(19) United States
(12) Patent Application Publication
(10) Pub. No.: US 2016/0082897 A1
(43) Pub. Date: Mar. 24, 2016

(54) CAMERA WITH PRIVACY COVER

(71) Applicant: NAVIGATION SOLUTIONS, LLC, Plano, TX (US)

(72) Inventors: Michael James Mouser, Parker, TX (US); Donald James Finney, JR., West Bloomfield, MI (US)

(21) Appl. No.: 14/689,527

(22) Filed: Apr. 17, 2015

Related U.S. Application Data
(60) Provisional application No. 61/980,735, filed on Apr. 17, 2014.

(51) Int. Cl. B60R 11/04; H04N 7/18; H04N 5/225

(52) U.S. Cl. CPC B60R 11/04; H04N 5/2252; H04N 7/183; B60R 2011/0003

(57) ABSTRACT

A camera assembly includes a housing. A camera is mounted to the housing. A cover is disposed over the camera. The cover has a variable opacity. When the camera is being used, such as for authentication, the cover is substantially transparent. When the camera is not being used, the cover is substantially opaque, to reassure the user's sense of privacy.

### BACKGROUND

The present invention provides an authentication system that uses a camera.

There are many ways in which a camera can be used as part of an authentication system. For example, the camera can be used to take an image of a person's face and through facial recognition software determine whether to authenticate that person. However, the presence of the camera can make the person uncomfortable after the authentication is completed.

### SUMMARY

A camera assembly includes a housing. A camera is mounted to the housing. A cover is disposed over the camera. The cover has a variable opacity. When the camera is being used, such as for authentication, the cover is substantially transparent. When the camera is not being used, the cover is substantially opaque, to reassure the user's sense of privacy.

### BRIEF DESCRIPTION OF THE DRAWINGS

FIG. 1 is a front view of an authentication system according to one embodiment of the present invention.

FIG. 2 is a schematic of the authentication system.

FIG. 3 is a front wireframe view of the authentication system.

FIG. 4 is a top view of the authentication system.

FIG. 5 is a plan view of the authentication system installed in an interior of a vehicle.

### DETAILED DESCRIPTION

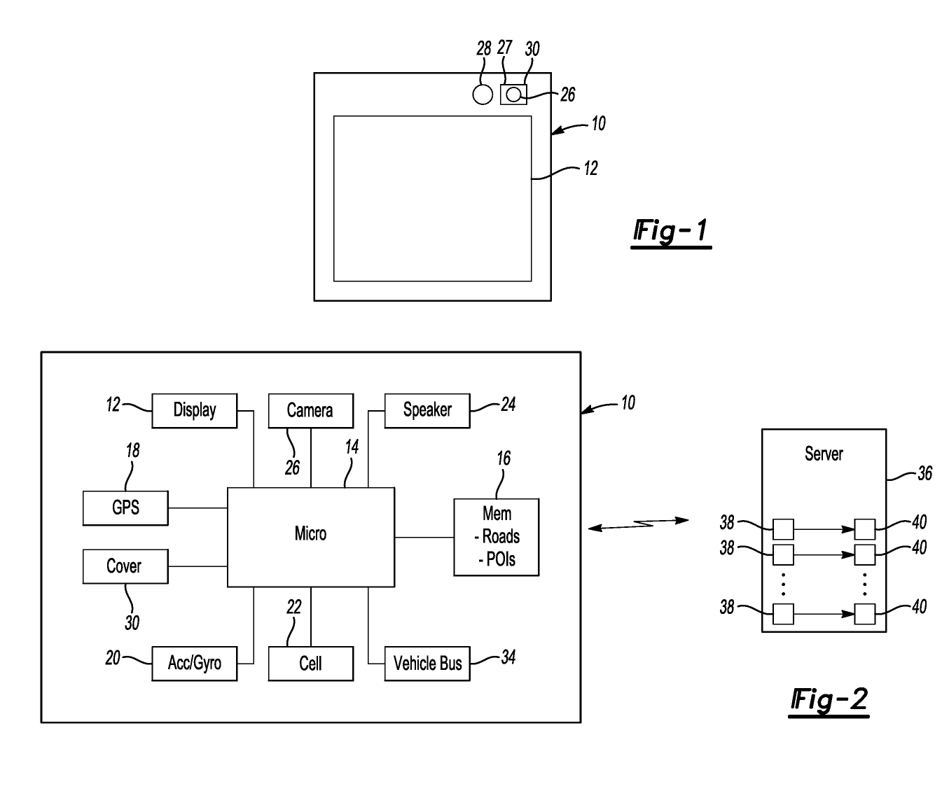

An authentication system 10 according to one example of the present invention is shown in FIG. 1. The authentication system 10 may include a display 12, which may be a touchscreen display. The authentication system may be installed or at least located in a vehicle (not shown). The authentication system 10 includes an embedded camera 26 (shown behind an opening 27 covered by cover 30) and a flash 28 (such as an LED flash) proximate the camera 26.

The example embodiment of the authentication system 10 is shown and described herein as part of a navigation system installed into a vehicle; however, it should be noted that the navigation functions are not critical to the present invention. Further, the authentication system 10 could be installed as part of the OEM vehicle equipment, as part of the vehicle interior, or as shown, as a separately installed appliance. The particular example described below is in the context of a navigation system in a rental vehicle, where the authentication can be used to authenticate a driver of the rental vehicle. Again, this context is primarily for purposes of illustration, as the invention is not limited to rental vehicles or to vehicles.

FIG. 2 is a high-level schematic showing some components of the authentication system 10, again in the exemplary configuration as part of a navigation system. The authentication system 10 includes at least one microprocessor 14 having memory 16 (or other computer accessible storage). The memory 16 stores the programs executed by the microprocessor 14 for performing the functions described herein. The memory 16 also stores a database of roads and a database of points of interest to which the user can request a route via the roads. The databases of roads and points of interest may cover a plurality of states, provinces and/or countries. Of course, the microprocessor 14 could be multiple microprocessors or multiple cores or multiple virtual processors and the memory 16 could be any combination of electronic, magnetic, optical or even off-board storage.

The authentication system 10 may also contain one or more position-determining devices, such as GPS 18, accelerometer/gyro 20, etc. The authentication system 10 may include wireless communication, such as cell circuitry 22. The authentication system 10 may include a speaker 24 for communicating routing instructions to the driver.

The particular configuration of the hardware, route guidance and position-determining hardware and software is not critical to the present invention. Many configurations are known.

As shown in FIG. 2, the authentication system 10 may be in communication with the vehicle ignition, such as via the vehicle bus 34 (e.g. OBD-II or variations thereof). Via this communication, the authentication system 10 can give the vehicle a command whether or not to permit use of the vehicle (either by preventing ignition, in the case of an ICE, or preventing activation of an electric motor, or any way in which use or movement of the vehicle can be selectively prevented/permitted).

The authentication system may be in communication with a remote server 36, such as via the cell circuitry 22 (or any other communication system off the vehicle). The remote server 36 stores a plurality of user profiles 38 and a plurality of vehicle profiles 40. The vehicle profiles 40 may contain identifying information for a plurality of vehicles in a fleet, such as rental vehicles. The vehicle profiles 40 may include information indicating make, model, year, accessories, VIN, mileage (as continuously or periodically updated by the system 10), current location (as may be updated continuously or as appropriate by the system 10). The user profiles 38 may contain identifying information for a plurality of users or potential users (renters) of the vehicles in the rental fleet, such as information identifying one or more of the following: name, address, account number, payment methods, driver's license number, status (such as preferred customer status), rental history, rental preferences, currently-active rentals, current reservations, currently-authorized vehicles (e.g. links to the vehicle profile(s) of currently assigned/rented vehicle(s)). The user profile 38 may also include a photo of the user's face or identifying characteristics of the user's face, as may be gathered from one or more photos.

In the exemplary embodiment, the authentication system 10 can use the camera 26 for user authentication for the rental of the vehicle. For example, the camera 26 can be used to take a photo of the user and/or the user's driver's license or other authenticating documents. The image may be processed on board and/or transmitted to the server 36 (or a different server) for verification that the user is authorized to drive the vehicle. The server 36 may perform the authentication automatically (by a processor on the server 36) or the authentication may be performed by a person accessing the server 36. The server 36 may authenticate the user by comparing the image of the user to an image stored in the server 36, or by comparing the image of the driver's license (or the information gleaned from the image) to the driver's license information stored in the user's profile 38. If the server 36 authenticates the user to drive the vehicle, the server 36 may send the authentication system 10 a confirmation signal. Upon receiving the confirmation signal from the server 36, the authentication system 10 may send a signal to the vehicle bus 34 permitting the vehicle to start or to move. The camera 26 could also be used for reading barcodes or QR codes from a user, reading an address (e.g. for a navigation destination), reading a PIN code or other user identification information.

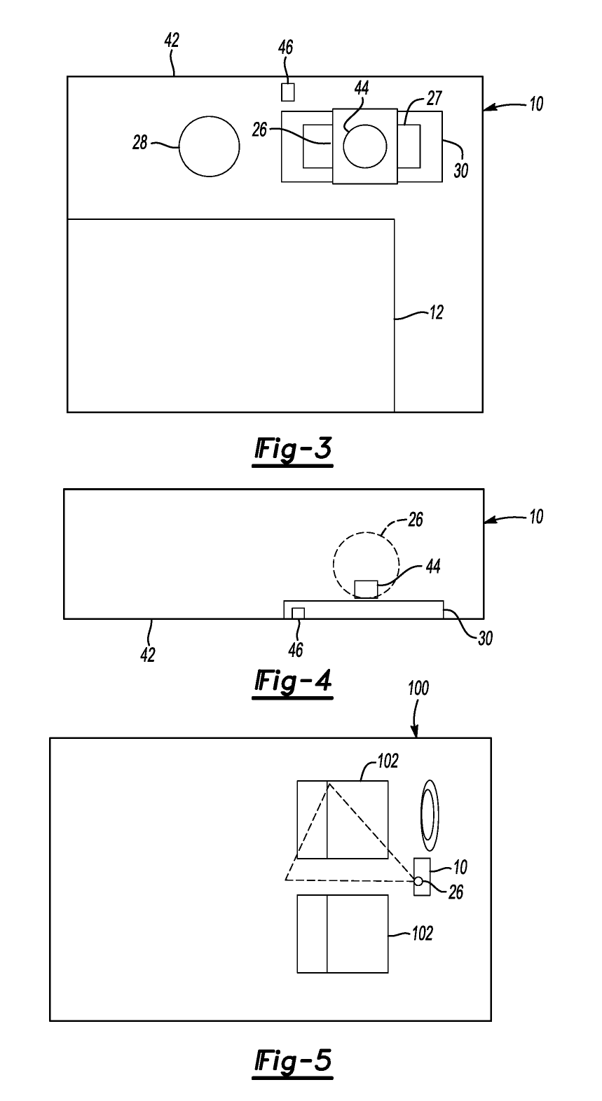

FIG. 3 is a front view of a portion of the authentication system 10 and FIG. 4 is a top view of the portion of the authentication system 10 of FIG. 3.

As shown in FIGS. 3-4, the authentication system 10 includes a housing 42 in which the opening 27 is formed through an otherwise opaque housing 42. The cover 30 is mounted over the opening 27. The cover 30 is electrochromatic film or TN film adhered to or part of material being of glass or plastic composition. The cover 30 has a variable (adjustable or switchable) opacity such as by using electrochromic, photochromic, thermochromic, suspended particle, micro-blind and liquid crystal devices. The cover 30 has at least two modes: a first mode (or “imaging mode”) where the cover 30 is substantially transparent (i.e. capable of permitting an image of sufficient quality to reach the camera 26) and a second mode (or “privacy mode”) where the cover 30 is substantially opaque or otherwise substantially interferes with the ability of the camera 26 to receive an image. Preferably, but not critically, the user can visually detect whether the cover 30 is in the first mode or the second mode, e.g. the user can see the camera lens or cannot see the camera lens, or the cover 30 appears black or appears transparent.

The cover 30 is opaque or dark when de-energized and transparent when energized (or vice versa). This is dependent on the properties of the electrochromatic or TN film selected. Suitable materials are used on windows for homes and business for the control of sunlight and radiant energy.

As an example, FIG. 5 is a plan view of the authentication system 10 installed in an interior of a vehicle 100. The camera 26 is oriented toward a seating area 102 within the interior of the vehicle 100. When authentication is required, the microprocessor 14 commands the cover 30 (FIGS. 3-4) to change from opaque (second mode) to transparent (first mode). The image is then taken by the camera 26 (whether it be an image of the user's face, driver's license, etc). After a suitable image is obtained, the microprocessor 14 commands the cover 30 to return to the opaque (second mode). This acts very similar to a camera lens cover, in that the cover 30 prevents any images from being taken when opaque and the user can see when the cover 30 is opaque. The camera 26 cannot image with clarity when the cover 30 is in the second mode and it provides the driver and or passenger a sense of privacy that the camera is “off” and the camera lens is covered.

The cover 30 may be used for other systems within a vehicle. For example, a display within the vehicle for non-critical elements to operation of a vehicle could be selectively covered by adjustably opaque material. Alternatively, a display of critical elements to operation of a vehicle could also be selectively covered by adjustably opaque material.

As another example, the instrument panel within the vehicle could be selectively covered by the adjustably opaque material, as a deterrent from theft. As another example, the windows of the vehicle including the front windscreen, side windows and rear windows, or internal dividing windows (e.g. between driver and second row passengers) could be formed with the adjustably opaque material.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A camera assembly comprising:
a housing;
a camera mounted to the housing; and
a cover disposed over the camera, the cover having a variable opacity.

2. The camera assembly of claim 1 wherein the cover has a first mode in which the cover is substantially transparent and a second mode in which the cover is substantially opaque.

3. The camera assembly of claim 1 wherein the camera is part of an authentication system installed in a vehicle.

4. The camera assembly of claim 1 further including at least one position sensor within the housing.

5. The camera assembly of claim 4 wherein the at least one position sensor includes a gps receiver.

6. The camera assembly of claim 4 further including a processor within the housing, the processor receiving position information from the at least one position sensor and digital image information from the camera.

7. The camera assembly of claim 6 wherein the processor is programmed to provide navigation instructions based upon the position information.

8. The camera system of claim 1 wherein the cover is electrochromatic.

9. An authentication system comprising:
a housing installed in a vehicle;
at least one position sensor;
a camera mounted to the housing;
a variable opacity cover mounted over the camera; and
a processor within the housing, the processor receiving position information from the at least one position sensor, the processor receiving the image from the camera, the processor programmed to authenticate operation of the vehicle based upon the image of the occupant, the processor controlling the opacity of the cover.

9. The authentication system of claim 8 wherein the at least one position sensor includes a gps receiver.

10. The authentication system of claim 9 wherein the processor is programmed to provide navigation instructions based upon the position information.

11. A method for taking an image in a vehicle including the steps of:
a) presenting an object to a camera in a housing in a vehicle while the camera is in a first position relative to the housing;
b) causing the camera to take an image of the object; and
c) after said steps a) and b), increasing an opacity of a cover disposed in front of the camera.

12. The method of claim 11 wherein step c) includes the step of increasing the opacity to substantially opaque.
